(19) United States
(12) Patent Application Publication
(10) Pub. No.: US 2014/0333230 A1
(43) Pub. Date: Nov. 13, 2014

(54) Device for recovering, storing and retrieving electricity for a handling door

(71) Applicants: Anne Sophie PANSERI, Montanay (FR); Armand POYET, Lyon (FR); Romain SIMON, Caluire (FR)

(72) Inventors: Anne Sophie PANSERI, Montanay (FR); Armand POYET, Lyon (FR); Romain SIMON, Caluire (FR)

(73) Assignee: SOFINECO, Decines (FR)

(21) Appl. No.: 14/271,593

(22) Filed: May 7, 2014

Related U.S. Application Data
(60) Provisional application No. 61/820,250, filed on May 7, 2013.

(30) Foreign Application Priority Data
May 7, 2013 (FR) 1354163

(51) Int. Cl. H02P 27/06

(52) U.S. Cl. CPC H02P 27/06
USPC 318/3

(57) ABSTRACT

The device for recovering, storing and retrieving electricity from the decelerations of an electromechanical system such as a flexible curtain of a handling door is made up of a management interface (IG) connected to a frequency inverter (VF) and to a control logic board (CC) controlling the opening and closing of the flexible curtain of a handling door, the management interface (IG) including at least two power capacitors (C1, C2) connected to the grid via a first parallel branch, then connected to the grid during use of the energy by a serial connection in order to make it possible to store the energy from the decelerations and to retrieve the energy either during the following acceleration during opening of the flexible curtain or, in case of failure, to ensure sufficient opening of the flexible curtain of the handling door.

The present invention relates to a device for recovering, storing and retrieving electricity for a handling door with a flexible curtain.

When an industrial system is produced driving a mechanical load via an electric motor with alternating current, we see two possible operating cases, namely:
The first operating case is characterized by the fact that the electric motor drives the mechanical load; the system then consumes electricity;
The second operating case is characterized by the fact that the mechanical load drives the electric motor; the system then produces electricity.

To date, several possible solutions exist regarding the control mode for the electric motors of an industrial system, namely:
The first solution uses changeover contactors making it possible to return energy to the power supply grid when the system produces energy. The energy consumption balance of the system is positive, but has the drawback of not being able to store that energy to allow use of the system for example in case of power outage of the power supply.
The second solution uses so-called “frequency variation” apparatuses, which are generally made up of a first stage for rectifying the alternating voltage to direct voltage and a second stage for transformation into acceptable direct voltage into alternating voltage for alternating current motors with a possibility of modifying the output frequency. When the motor is driven by the loop, this solution does not make it possible to return the energy production to the electricity grid and to store the energy for periodic use of the system. Additionally, this solution has a relatively low energy output to be suitable for applications such as handling doors with a high opening and closing frequency of the flexible curtain.

The device for recovering, storing and retrieving electricity according to the present invention aims on the one hand to store the energy from the decelerations of an electromechanical system, and on the other hand to retrieve that energy during the following acceleration of said electromechanical system during movements between an opening and closing position of the flexible curtain of a handling door.

The device for recovering, storing and retrieving electricity according to the present invention consists of a management interface connected on the one hand to a frequency inverter, and on the other hand to a logic control board controlling the opening and closing of the flexible curtain of a handling door, said management interface including at least two power capacitors connected to the grid by means of a first parallel connection, then connected to the grid during use of the energy by a serial connection in order to make it possible to store the energy from the decelerations and to retrieve said energy either during the following acceleration during opening of the flexible curtain or, in case of failure, to ensure sufficient opening of said flexible curtain of the handling door.

The device for recovering, storing and retrieving electricity according to the present invention comprises a management interface including a power transistor allowing voltage regulation.

The device for recovering, storing and retrieving electricity according to the present invention comprises a frequency inverter including a power supply input that is connected to the single- or three-phase alternating current power supply grid, a rectifier bridge for turning the alternating voltage into a direct voltage, and a solid-state system making it possible to re-transform the current into three alternating phases.

The device for recovering, storing and retrieving electricity according to the present invention comprises a frequency inverter including connection terminals allowing the connection of an electric motor belonging to a handling door to ensure movements between an open position and a closed position of a flexible curtain.

The following description, done in light of the appended drawings, provided as non-limiting examples, will make it possible to better understand the invention, the features thereof and the advantages it may procure:

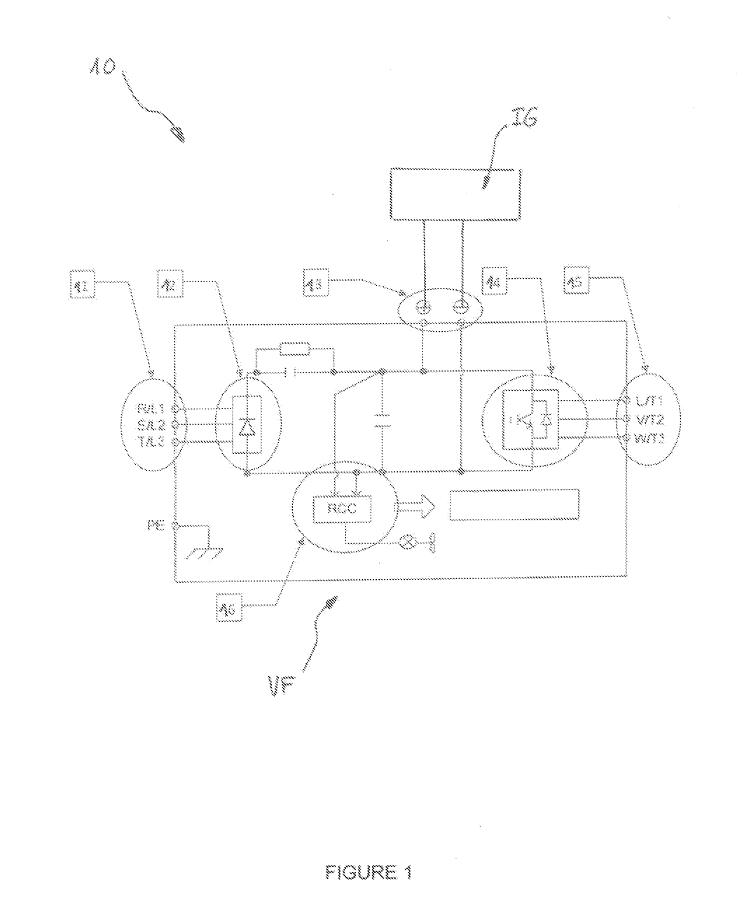

FIG. 1 is a block diagram showing a frequency inverter used in the operating method of the device for recovering, storing and retrieving electricity according to the present invention.

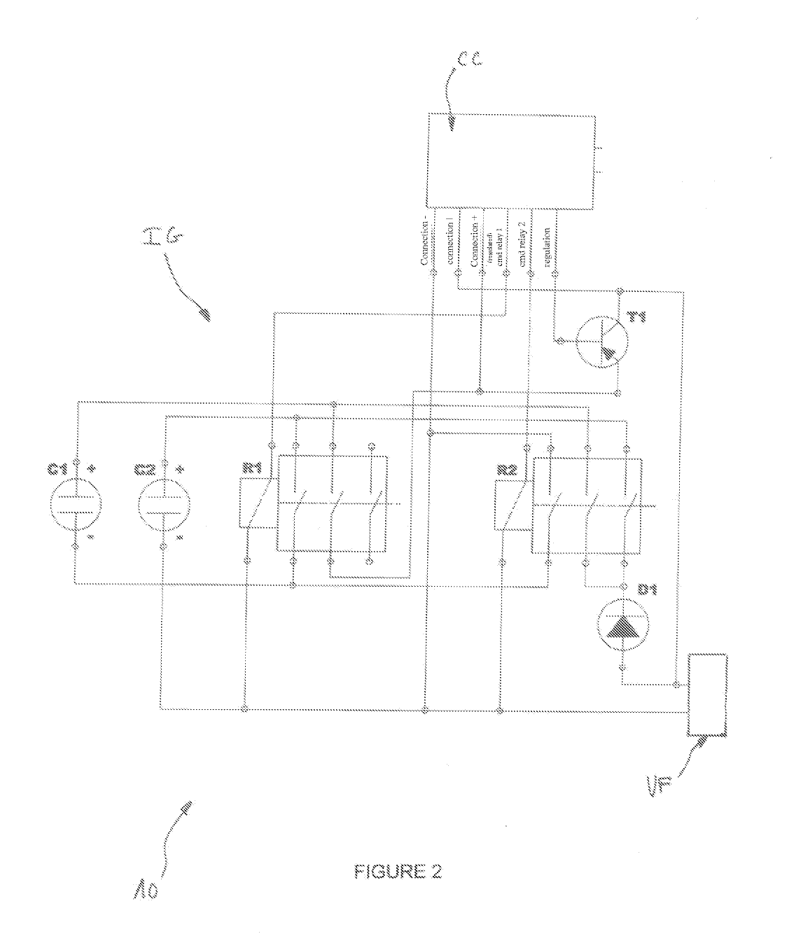

FIG. 2 is a diagrammatic view illustrating the management interface of the device for recovering, storing and retrieving electricity according to the present invention.

FIGS. 1 and 2 show a device for recovering, storing and retrieving electricity 10 that consists of a management interface IG connected across the output terminals of the direct grid 13 of a frequency inverter VF.

The frequency inverter VF includes a power supply input 11 of the system that is connected to the single- or three-phase alternating current power supply grid.

The frequency inverter VF comprises a rectifier bridge 12 for rectifying the alternating voltage into direct voltage.

The frequency inverter VF includes a solid-state system 14 making it possible to re-transform the current into three alternating phases.

The frequency inverter VF is made up of a connection terminal 15 allowing the connection of an electric motor, not shown, belonging to a handling door to ensure the movements between an open position and a closed position of a flexible curtain.

The frequency inverter VF comprises a filtering and power supply element 16 of the ventilation and control system of the device for recovering, storing and retrieving electricity 10.

The management interface IG includes two power capacitors C1, C2 whereof the capacity is sufficient to provide a backup power supply in case of failure of the handling door and to allow opening of the flexible curtain.

The two capacitors C1, C2 of the management interface IG are connected to the grid by means of the first parallel connection, then connected to the grid during use of the energy by a serial connection.

The voltage regulation is done by a power transistor T1.

The management interface IG is connected to a control logic board CC connected to the opening and closing control system of the handling door.

Thus, the management interface IG must be capable of operating independently and making operating decisions on the basis of voltage fluctuations observable on the direct current grid inside the frequency inverter VF.

The normal operating voltage level U of the direct grid is set by the electric power supply through the rectifier bridge 12 of the frequency inverter VF.

### OPERATION OF THE MANAGEMENT INTERFACE IG

### During Opening of the Flexible Curtain of the Handling Door

The management interface IG must maintain a voltage U+k as long as there is backup energy, which makes it possible to block the rectifier bridge 12 of the frequency inverter VF upstream. “k being the additional voltage in addition to that delivered by the grid”. To determine the opening state of the flexible curtain of the handling door, the ascent information of the flexible curtain is taken at the opening request contact (direction of rotation) that is cabled on the input of the frequency inverter VF.

### During Closing of the Flexible Curtain of the Handling Door

The management interface IG must analyze the voltage U+k+f and switch into recharge mode for the capacitors C-1 and C-2. To determine the opening state of the flexible curtain, the descent information of said curtain is taken at the closing request contact (direction of rotation), which is cabled on the input of the frequency inverter VF. “f being the additional voltage in addition to that delivered by the grid”.

### When the Flexible Curtain of the Handling Door Stops in the Lowered Position

It will be noted that if the recharge time is not sufficient during the stop, then the bottom end-of-travel information will automatically switch the management interface IG into the charging position.

The device for recovering, storing and retrieving electricity 10 according to the present invention makes it possible to store energy from decelerations and to retrieve said energy either during the following acceleration during opening of the flexible curtain, or in case of failure to ensure sufficient opening of the flexible curtain of the handling door.

It must also be understood that the preceding description has been provided solely as an example and that it in no way limits the scope of the invention; it would not be outside the scope of the invention to replace the described embodiment details with any other equivalent means.

1. A device for recovering, storing and retrieving electricity from decelerations of an electromechanical system such as a flexible curtain of a handling door, characterized in that it consists of a management interface (IG) connected on the one hand to a frequency inverter (VF), and on the other hand to a logic control board (CC) controlling the opening and closing of the flexible curtain of a handling door, said management interface (IG) including at least two power capacitors (C1, C2) connected to the grid by means of a first parallel connection, then connected to the grid during use of the energy by a serial connection in order to make it possible to store the energy from the decelerations and to retrieve said energy either during the following acceleration during opening of the flexible curtain or, in case of failure, to ensure sufficient opening of said flexible curtain of the handling door.

2. The device for recovering, storing and retrieving electricity according to claim 1, characterized in that the management interface (IG) includes a power transistor (T1) allowing voltage regulation.

3. The device for recovering, storing and retrieving electricity according to claim 1, characterized in that the frequency inverter (VF) includes a power supply input (11) that is connected to the single- or three-phase alternating current power supply grid, a rectifier bridge (12) for turning the alternating voltage into a direct voltage, and a solid-state system (14) making it possible to re-transform the current into three alternating phases.

4. The device for recovering, storing and retrieving electricity according to claim 3, characterized in that the frequency inverter (VF) includes connection terminals (15) allowing the connection of an electric motor belonging to a handling door to ensure movements between an open position and a closed position of a flexible curtain.
